(19) United States
(12) Patent Application Publication
(10) Pub. No.: US 2008/0151727 A1
(43) Pub. Date: Jun. 26, 2008

(54) OPTICAL DISK AND OPTICAL DISK APPARATUS USING THE SAME

(76) Inventors: Naomasa Nakamura, Yokohama-shi (JP); Nobuhisa Yoshida, Kamakura-shi (JP); Yasuaki Ootera, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/958,137

(22) Filed: Dec. 17, 2007

(30) Foreign Application Priority Data
Dec. 20, 2006 (JP) 2006-342564
Dec. 7, 2007 (JP) 2007-317511

(51) Int. Cl. G11B 7/20; G11B 7/26

(52) U.S. Cl. 369/94; 369/283

(57) ABSTRACT

According to one embodiment, in a single-sided, triple-layered optical disk, at least a first reflecting layer on the light incident side is made of silicon or a silicon compound, and has a recording density lower than those of second and third reflecting layers.

### CROSS-REFERENCE TO RELATED APPLICATIONS

This application is based upon and claims the benefit of priority from prior Japanese Patent Applications No. 2006-342564, filed Dec. 20, 2006; and No. 2007-317511, filed Dec. 7, 2007, the entire contents of which are incorporated herein by reference.

### BACKGROUND

1. Field

One embodiment of the present invention relates to a multilayered optical disk such as a CD, DVD, Blu-Ray Disc (BD), or DVD capable of recording information.

2. Description of the Related Art

Presently, optical disks such as a CD and DVD are generally used as media for recording digital information. Of these optical disks, a DVD or an HD DVD currently being standardized as a next-generation optical disk has a disk structure obtained by adhering two plastic substrates. This makes it possible to relatively easily increase the capacity by using two information recording layers.

In a single-sided, double-layered disk like this, as disclosed in, e.g., Jpn. Pat. Appln. KOKAI Publication No. 2004-355701, a first reflecting layer made of silver or a silver alloy and a second reflecting layer made of aluminum or an aluminum alloy material are formed in this order from the side facing an optical pickup head for reproducing information, in order to equalize the reflectances of the two layers with respect to a blue laser.

Unfortunately, silver that is chemically active and has a low environmental resistance has the drawback that it reacts with, e.g., oxygen in air and changes its color to black, thereby readily lowering the reflectance of the reflecting layer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view showing the sequence of a multilayered disk manufacturing method according to an embodiment of the present invention;

FIG. 2 is a view showing the sequence of a method of manufacturing a single-sided, triple-layered optical disk; and

FIG. 3 is a view for explaining the arrangement of an optical disk apparatus according to the present invention.

### DETAILED DESCRIPTION

Various embodiments according to the invention will be described hereinafter with reference to the accompanying drawings. In general, according to one embodiment of the present invention, there is provided an optical disk comprising first, second, and third reflecting layers which are sequentially formed on a transparent substrate, and in each of which information is recorded by a pit pattern, wherein the recording density of the first reflecting layer is lower than those of the second and third reflecting layers, and at least the first reflecting layer is made of silicon or a silicon compound.

Also, an optical disk apparatus of the present invention uses the above optical disk, and comprises a light-emitting unit which emits a laser beam to the optical disk, a light-receiving unit which receives the reflected light of the laser beam emitted from the light-emitting unit, and a reproducing unit which reproduces information recorded in the reflecting layer on the basis of the received reflected light.

In the present invention, silicon or its compound used in at least the first reflecting layer is chemically less active and stabler than silver. Accordingly, it is possible to obtain an optical disk having a high environmental resistance, and well reproduce information.

Information recorded in the first reflecting layer can be reproduced by light having a wavelength of 650 nm. To well reproduce information, the first reflecting layer can be formed to have a reflectance of 45% or more to light having a wavelength of 650 nm. Note that if the reflectance exceeds 85%, the reflectance of other layers are less than 1%. Therefore, the reflectance can be 45% to 85%.

Examples of the silicon compound used in the first reflecting layer are silicon oxide, silicon carbide, and silicon nitride.

Also, the thickness of the first reflecting layer can be, e.g., 30 to 40 nm.

A reflecting layer having a film thickness of less than 30 nm is difficult to form. If the film thickness exceeds 40 nm, the reflectance of other layers tend to decrease and it is difficult to read out these layers.

The reflectance of the second reflecting layer to light having a wavelength of 405 nm can be 3% to 20%.

Examples of the material used in the second reflecting layer are silver, a silver compound, silicon, and a silicon compound. According to an aspect of the present invention, the material used in the second reflecting layer is silicon or a silicon compound.

The second reflecting film has a film thickness of 30 to 40 nm.

It is difficult to form a reflecting layer having a film thickness of less than 30 nm. If the film thickness exceeds 40 nm, the reflectance of 3^{rd} later often decreases and it is difficult to read out this layer.

Examples of the material used in the third reflecting layer are aluminum and an aluminum compound.

The third reflecting film has a film thickness of 30 to 50 nm.

In the case of a reflecting layer having a film thickness of less than 30 nm, it is difficult to obtain enough reflectance for read out from 3^{rd} layer. If the film thickness exceeds 40 nm, the quality of read out signal tend to deteriorate.

It is also possible to form a first interlayer between the first and second reflecting layers, and a second interlayer between the second and third reflecting layers.

Examples of the material of the interlayers are polymethylmethacrylate, photopolymers such as urethaneacrylate.

Embodiments of the present invention will be explained in detail below with reference to the accompanying drawings.

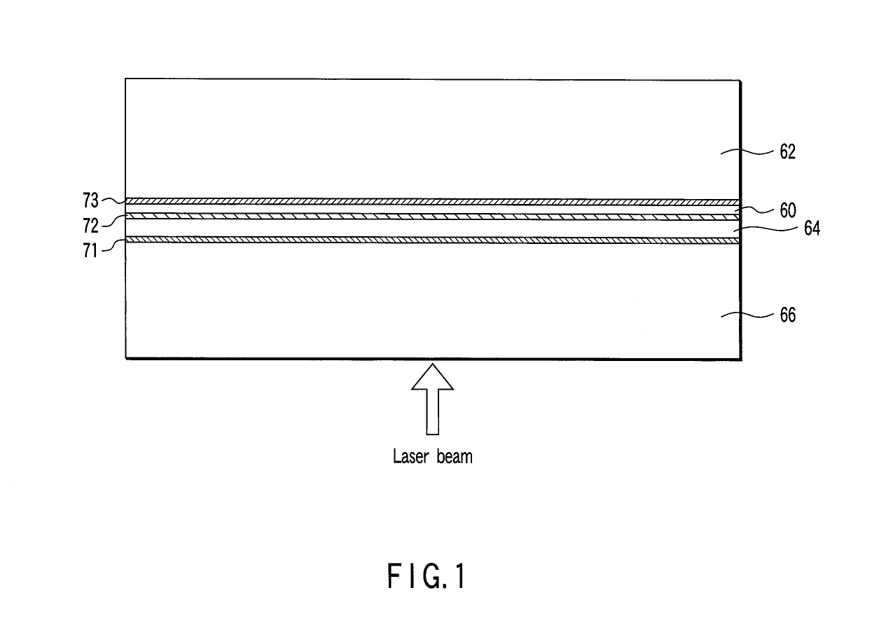

FIG. 1 is a view showing the structure of a single-sided, triple-layered optical disk having one DVD layer and two HD DVD layers.

This example shown in FIG. 1 is a read only disk having three layers, i.e., one DVD layer and two HD DVD layers on one side. A signal pattern of a first layer 71 is formed on a first signal substrate 66, a signal pattern of a third layer 73 is formed on a second signal substrate 62, and a signal pattern of a second layer 72 is formed on a photopolymer.

The layer arrangement is that the first layer is a DVD layer, and the second and third layers are HD DVD layers. A reproducing optical system for the DVD layer has a wavelength of 650 nm as a red laser beam 54 and uses an objective lens 56 having NA of 0.6, and a reproducing optical system for the HD DVD layers has a wavelength of 405 nm as a blue laser beam 52 and uses an objective lens 50 having NA of 0.65. Of these information recording layers, pits having a shortest length of 0.4 μm are spirally formed at a track pitch of 0.74 μm in the DVD layer, and pits having a shortest length of 0.204 μm are spirally formed at a track pitch of 0.40 μm in the HD DVD layers. The dimensions of the disk are an outer diameter of 120 mm, an inner diameter of 15 mm, and a total thickness of 1.2 mm±0.03 mm, i.e., the same as those of a CD or DVD (or HD DVD or BD). In the optical disk according to the present invention, the DVD layer (first layer), the HD DVD layer (second layer), and the HD DVD layer (third layer) are arranged in this order from the light incident side.

The DVD layer has a reflectance of 45% or more when reproducing information with a wavelength of 650 nm, and can be played back by a commercially available DVD player. In the optical disk of the present invention, the first, second, and third layers respectively have a semitransparent first reflecting layer; a semitransparent second reflecting layer, and a third reflecting layer as a total reflecting layer for reflecting light. In the present invention, the materials of these reflecting layers are that Si (silicon) or its compound is used as the first reflecting layer, Si or its compound or AG (silver) or its alloy is used as the second reflecting layer, and Al (aluminum) is used as the third reflecting layer.

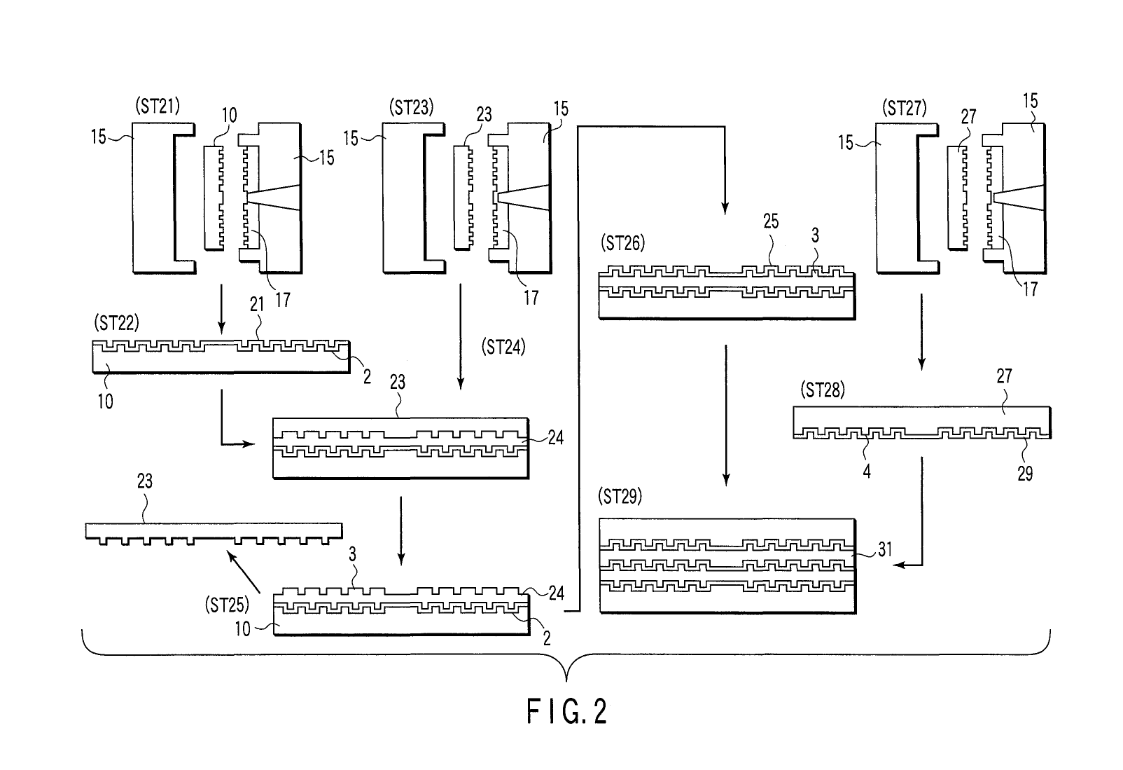

A method of manufacturing the single-sided, triple-layered optical disk having the DVD layer and two HD DVD layers as an example of the present invention will be explained below with reference to FIG. 2.

First, a first layer molding substrate 10 (the first signal substrate 66 shown in FIG. 1) on which the first layer (DVD) is transferred is formed by injection molding using a mold 15 and Ni stamper 17 (ST21). This step is the same as that for the conventional single-layered and double-layered DVD and HD DVD. The molding material is generally polycarbonate, and the Ni stamper 17 as a mold is obtained by plating a master formed by lithography. A semitransparent reflecting film 21 made of Si and having a thickness of, e.g., 35 nm is formed on a pit pattern 2 of the first layer molding substrate 10 as the DVD layer formed in ST21 (ST22).

At the same time, a plastic stamper 23 of the second layer as the HD DVD layer is similarly formed by injection molding (ST23). Although the material of the plastic stamper 23 is generally a cycloolefin polymer, it is also possible to use PMMA (Polymethylmethacrylate) or polycarbonate. In this injection molding, the Ni stamper 17 is used as in ST21, and facilities such as a molding machine and the metal mold 15 are basically those used for the conventional DVD. The first layer molding substrate 10 and plastic stamper 23 thus prepared are adhered by a photopolymer 24 and cured with ultraviolet radiation (ST24).

The photopolymer 24 is generally formed by spin coating. This layer functions as a pit pattern transfer layer of the second layer, and an interlayer (the first interlayer 64 shown in FIG. 1) for separating the first and second layers. After the photopolymer is cured, the plastic stamper 23 is removed (ST25). Then, a semitransparent reflecting film 25 made of Si or Ag and a thickness of, e.g., 35 nm is formed on a pit pattern 3 (of the second layer) formed by the exposed photopolymer 24 (ST26).

At the same time, a third layer molding substrate 27 (the second signal substrate 62 shown in FIG. 1) on which the third layer as the HD DVD layer is transferred is formed by injection molding (ST27). This step is also the same as that for the conventional double-layered DVD or HD DVD, i.e., the substrate is generally molded by using polycarbonate and the Ni stamper 17. A total reflecting film 29 made of Al and a thickness of, e.g., 35 nm is formed on a pit pattern 4 of the third layer molding substrate 27 (ST28). The third layer molding substrate 27 thus prepared is adhered on the pit pattern 3 of the second layer by an ultraviolet-curing resin 31 (ST29). This step is the same as an adhesion step of the conventional double-layered DVD or HD DVD, and the adhesive layer functions as an interlayer (the second interlayer shown in FIG. 1) for separating the second and third layers. In this manner, the single-sided, triple-layered optical disk is obtained.

In the triple-layered optical disk having the DVD layer and two HD DVD layers formed by the above method, the reflectance of the DVD layer must allow playback by a commercially available DVD player. The DVD standards require a reflectance of 45% or more at a wavelength of 650 nm. In the optical disk of the present invention, the two HD DVD layers are arranged next to the DVD layer when viewed from the light incident surface. Therefor, light having a wavelength of 405 nm used to play back an HD DVD must pass through the DVD layer and play back the two HD DVD layers.

Generally, Ag or an Ag alloy is used as the reflecting layer material in order to achieve both the high reflectance (45% or more) at a wavelength of 650 nm and the transmittance at a wavelength of 405 nm. However, Ag is chemically active and readily reacts with the surrounding environment to form an oxide or sulfide. This poses the problem that corrosion or the like occurs at a high temperature and a high humidity, and the playback characteristics deteriorate.

To solve the above problem, Si that is chemically stable was used as the reflecting layer material of the DVD layer (first layer) and HD DVD layer (second layer) of the optical disk of the present invention. As a consequence, it was possible to achieve a high reflectance (45% or more) at a wavelength of 650 nm and a sufficient transmittance at a wavelength of 405 nm.

### EXPERIMENTAL EXAMPLE 1

In practice, the single-sided, triple-layered optical disks of this embodiment were manufactured by forming two types of reflecting films made of Si (the reflecting film of the present invention) and Ag as the first and second layers, while the other layers were made of the same materials (the third layer was Al), and the reflectances were compared.

Table 1 shows the reflectances of the individual layers. As shown in Table 1, almost equal reflectances were obtained by Si of the present invention and Ag.

TABLE 1

| First layer/ | | | |
|---|---|---|---|
| second layer | First layer | Second layer | Third layer |
| material | reflectance | reflectance | reflectance |
| Si | 45% | 7.5% | 6% |
| Ag | 45% | 6% | 7% |

These two types of single-sided, triple-layered disks each having the DVD layer and two HD DVD layers were left to stand for 100 hrs in an environment at a temperature of 80° C. and a relative humidity of 85%, and the signal characteristics were measured before and after that. Table 2 compares the measurement results.

TABLE 2

| | | |
|---|---|---|
| First layer | SbER | PRSNR |

| characteristics | OH | 100H | OH | 100H |
|---|---|---|---|---|
| Si reflecting layer | 7.5 × 10⁻⁷ | 2 × 10⁻⁶ | 31.4 | 28.9 |
| Ag reflecting layer | 9.9 × 10⁻⁷ | 3 × 10⁻⁴ | 30.2 | 16.8 |

In these measurement results, the SbER (Simulated bit Error Rate) and PRSNR (Partial Response Signal Noise Ratio) are indices representing the signal quality of the HD DVD. The SbER equivalent to the error rate is desirably low, and the PRSNR equivalent to the signal-to-noise ratio is desirably high.

Table 2 shows that when the Si reflecting film was used, the signal quality was high even after the deterioration test at a high temperature and a high humidity, compared to the case that the silver reflecting film was used. In this embodiment, the Si layer thickness of the DVD layer (first layer), the Si layer thickness of the HD DVD layer (second layer), and the Al layer thickness of the HD DVD layer (third layer) were respectively 35, 33 and 40 nm.

### EXPERIMENTAL EXAMPLE 2

A triple-layered disk was manufactured by respectively changing the Si layer thickness of the DVD layer (first layer), the Si layer thickness of the HD DVD layer (second layer), and the Al layer thickness of the HD DVD layer (third layer) to 30, 40, and 40 nm in the above arrangement, and the reflectances were measured. Table 3 below shows the measured reflectances. The reflectance of the DVD layer was 45% or more.

TABLE 3

| First layer | Second layer | Third layer |
|---|---|---|
| reflectance | reflectance | reflectance |
| 46% | 4% | 4% |

Table 4 below shows the signal characteristics of the HD DVD layers (second and third layers). As shown in Table 4, sufficient signals were obtained in normal playback. Note that the standard values of the PRSNR and SbER are respectively 15 or more and 5×10⁻⁵ or less. Within these ranges, signal playback practically having no problem is possible.

TABLE 4

| | PRSNR | SbER |
|---|---|---|
| Second layer | 28 | 5.5 × 10⁻⁷ |
| Third layer | 31 | 8.2 × 10⁻⁷ |

### EXPERIMENTAL EXAMPLE 3

A triple-layered disk was manufactured by respectively changing the Si layer thickness of the DVD layer (first layer), the Si layer thickness of the HD DVD layer (second layer), and the Al layer thickness of the HD DVD layer (third layer) to 40, 30, and 40 nm in the above arrangement, and the reflectances were measured. Table 5 below shows the measured reflectances. The reflectance of the DVD layer was 45% or more.

TABLE 5

| First layer | Second layer | Third layer |
|---|---|---|
| reflectance | reflectance | reflectance |
| 52% | 5% | 5% |

Table 6 below shows the signal characteristics of the HD DVD layers (second and third layers). As shown in Table 6, sufficient signals were obtained in normal playback.

TABLE 6

| | PRSNR | SbER |
|---|---|---|
| Second layer | 26 | 4.6 × 10⁻⁶ |
| Third layer | 27 | 1.5 × 10⁻⁷ |

### EXPERIMENTAL EXAMPLE 4

A triple-layered disk was manufactured by respectively changing the Si layer thickness of the DVD layer (first layer), the Si layer thickness of the HD DVD layer (second layer), and the film thickness of the HD DVD layer (third layer) to 35, 30, and 50 nm in the above arrangement, and the reflectances were measured. Table 7 below shows the measured reflectances. The reflectance of the DVD layer was 45% or more.

TABLE 7

| First layer | Second layer | Third layer |
|---|---|---|
| reflectance | reflectance | reflectance |
| 45% | 4% | 14% |

Table 8 below shows the signal characteristics of the HD DVD layers (second and third layers). As shown in Table 8, sufficient signals were obtained in normal playback.

TABLE 8

| | PRSNR | SbER |
|---|---|---|
| Second layer | 23 | 7.7 × 10⁻⁶ |
| Third layer | 35 | 6.2 × 10⁻⁸ |

### EXPERIMENTAL EXAMPLE 5

A triple-layered disk was manufactured by respectively changing the Si layer thickness of the DVD layer (first layer), the Si layer thickness of the HD DVD layer (second layer), and the film thickness of the HD DVD layer (third layer) to 32, 38, and 30 nm in the above arrangement, and the reflectances were measured. Table 9 below shows the measured reflectances. The reflectance of the DVD layer was 45% or more.

TABLE 9

| First layer | Second layer | Third layer |
|---|---|---|
| reflectance | reflectance | reflectance |
| 45% | 5% | 4.5% |

Table 10 below shows the signal characteristics of the HD DVD layers (second and third layers). As shown in Table 10, sufficient signals were obtained in normal playback.

TABLE 10

| | PRSNR | SbER |
|---|---|---|
| Second layer | 23 | 7.7 × 10⁻⁶ |
| Third layer | 35 | 6.2 × 10⁻⁸ |

The reflecting films according to the present invention use Si and Al that are also used in the existing optical disks, and hence are compatible with the existing optical disk manufacturing lines. Accordingly, these reflecting films can be implemented by slightly changing the existing apparatus.

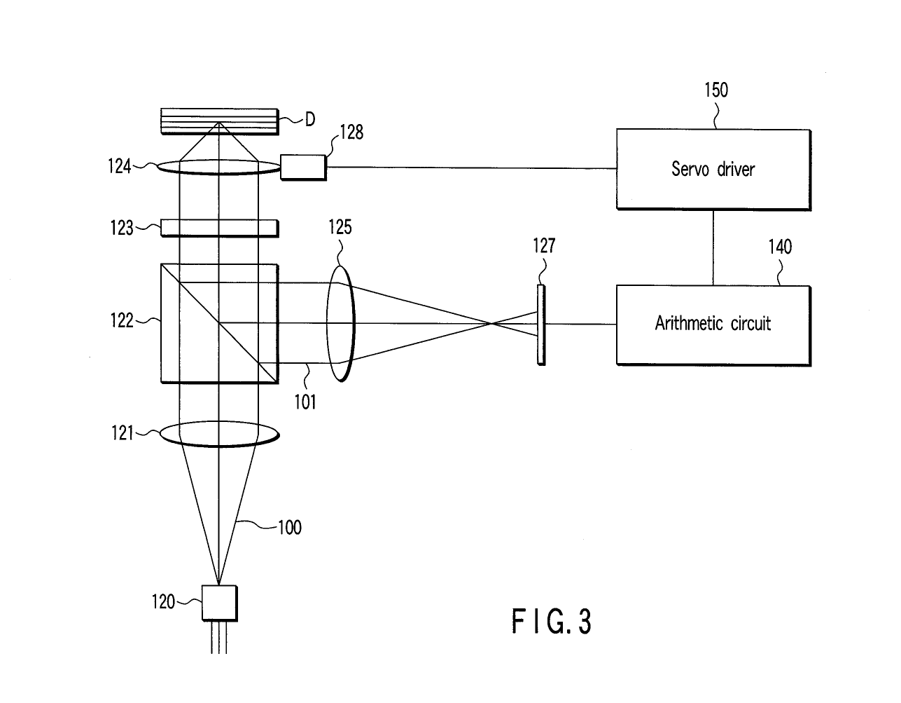

An optical disk apparatus for reproducing information recorded on the above-mentioned optical disk will be explained below. FIG. 3 is a block diagram showing an outline of the arrangement of the optical disk apparatus for playing back the optical disk. As shown in FIG. 3, an optical disk D is, e.g., the single-sided, triple-layered optical disk shown in FIG. 1. A short-wavelength semiconductor laser source 120 is used as a light source. The wavelength of the exit light is, e.g., the violet wavelength band within the range of 400 to 410 nm. Exit light 100 from the semiconductor laser source 120 is collimated into parallel light by a collimator lens 121, and enters an objective lens 124 through a polarizing beam splitter 122 and λ/4 plate 123. After that, the light is transmitted through the substrate of the optical disk D, and focused on each information recording layer. Reflected light 101 from the information recording layer of the optical disk D is transmitted through the substrate of the optical disk D again, transmitted through the objective lens 124 and λ/4 plate 123, and reflected by the polarizing beam splitter 122. After that, the light enters a photodetector 127 through a condenser lens 125.

A light-receiving portion of the photodetector 127 is normally divided into a plurality of light-receiving portions, and each light-receiving portion outputs an electric current corresponding to the light intensity. An I/V amplifier (current-to-voltage converter) (not shown) converts the output electric current into a voltage, and the voltage is input to an arithmetic circuit 140. The arithmetic circuit 140 processes the input voltage signal into, e.g., a tilt error signal, HF signal, focusing error signal, and tracking error signal. The tilt error signal is used to perform tilt control. The HF signal is used to reproduce information recorded on the optical disk D. The focusing error signal is used to perform focusing control. The tracking error signal is used to perform tracking control.

An actuator 128 can drive the objective lens 124 in the vertical direction, disk radial direction, and tilt direction (radial direction or/and tangential direction). A servo driver 150 controls the objective lens 124 such that it follows information tracks on the optical disk D. Note that the tilt direction includes two directions: “a radial tilt” produced when the disk surface inclines toward the center of the optical disk; and “a tangential tilt” produced in the tangential direction of tracks. Of these tilts, the warpage of a disk generally produces the radial tilt. It is necessary to take account of not only a tilt produced when the disk is manufactured, but also a tilt produced by aged deterioration or a rapid change of the use environment. The optical disk of the present invention can be played back by using the optical disk apparatus as described above.

As has been explained above, the optical disk of the present invention is a single-sided, triple-layered disk having a DVD layer and two HD DVD layers formed in this order. In this optical disk, light having a wavelength of 405 nm used to play back an HD DVD must play back the two HD DVD layers through the DVD layer. Therefore, Ag or an Ag alloy is used as the reflecting layer material in order to achieve both the high reflectance (45% or more) at a wavelength of 650 nm and the transmittance at a wavelength of 405 nm. When Ag (or an Ag alloy) is used, silver readily reacts with the surrounding environment because silver itself is chemically active and the film thickness of the reflecting layer is small. This poses problems in environmental resistance and the like. Therefore, the present invention uses Si or an Si compound instead of Ag (or an Ag alloy) as the reflecting layer. Si itself is chemically very stable, and hardly reacts with the surrounding environment. As a consequence, an optical disk having a high environmental resistance can be implemented.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk comprising a transparent substrate, and a first reflecting layer, a second reflecting layer, and a third reflecting layer which are sequentially formed on the transparent substrate, and in which information is recorded by pit patterns, wherein a recording density of the first reflecting layer is lower than recording densities of the second reflecting layer and the third reflecting layer, and at least the first reflecting layer is made of a material selected from the group consisting of silicon and a silicon compound.

2. A disk according to claim 1, wherein a reflectance of the first reflecting layer to light having a wavelength of 650 nm is 45% to 85%.

3. A disk according to claim 1, wherein the second reflecting layer is made of a material selected from the group consisting of silicon and a silicon compound, and the third reflecting layer is made of a material selected from the group consisting of aluminum and an aluminum alloy.

4. A disk according to claim 1, wherein a reflectance of the second reflecting layer to light having a wavelength of 405 nm is 3% to 20%.

5. A disk according to claim 1, wherein the first reflecting film has a film thickness of 30 to 40 nm, the second reflecting film has a film thickness of to 40 nm, and the third reflecting film has a film thickness of 30 to 50 nm.

6. An optical disk apparatus comprising:
a light-emitting unit which emits a laser beam to an optical disk including a transparent substrate, and a first reflecting layer, a second reflecting layer, and a third reflecting layer which are sequentially formed on the transparent substrate, and in which information is recorded by pit patterns, a recording density of the first reflecting layer is lower than recording densities of the second reflecting layer and the third reflecting layer, and at least the first reflecting layer is made of a material selected from the group consisting of silicon and a silicon compound;
a light-receiving unit which receives reflected light of the laser beam emitted from the light-emitting unit; and
a reproducing unit which reproduces information recorded in the reflecting layer on the basis of the received reflected light.

7. An apparatus according to claim 6, wherein a reflectance of the first reflecting layer to light having a wavelength of 650 nm is 45% to 85%.

8. An apparatus according to claim 6, wherein the second reflecting layer is made of a material selected from the group consisting of silicon and a silicon compound, and the third reflecting layer is made of a material selected from the group consisting of aluminum and an aluminum alloy.

9. An apparatus according to claim 6, wherein a reflectance of the second reflecting layer to light having a wavelength of 405 nm is 3% to 20%.

10. An apparatus according to claim 6, wherein the first reflecting film has a film thickness of 30 to 40 nm, the second reflecting film has a film thickness of 30 to 40 nm, and the third reflecting film has a film thickness of 30 to 50 nm.
